(19) United States
(12) Patent Application Publication
(10) Pub. No.: US 2023/0344070 A1
(43) Pub. Date: Oct. 26, 2023

(54) BATTERY PACK AND ELECTRIC VEHICLE

(71) Applicant: SAMSUNG SDI CO., LTD., Yongin-si (KR)

(72) Inventors: Miran KOJC, Hausmannstätten (AT); Mariagrazia MONTARULI, Graz (AT); Wolfgang REINPRECHT, Attendorf (AT)

(21) Appl. No.: 18/306,016

(22) Filed: Apr. 24, 2023

(30) Foreign Application Priority Data
Apr. 25, 2022 (EP) 22169616

(51) Int. Cl. H01M 50/358; H01M 10/6556; H01M 10/658

(52) U.S. Cl. CPC H01M 50/358; H01M 10/6556; H01M 10/658; H01M 2220/20

(57) ABSTRACT

A battery pack includes: a housing; a plurality of battery cells accommodated within the housing, each of the plurality of battery cells including a degassing valve; gas channel mounted to the housing as a structural member of the housing; and a thermally and electrically isolating sheet. The isolating sheet is arranged between the battery cells and the gas channel and is configured to provide conditional fluid communication between the gas channel and each of the degassing valves of the plurality of battery cells. The conditional fluid communication depends on whether or not one of the battery cells is ejecting and/or has ejected a venting gas through the degassing valve of the battery cell.

### CROSS-REFERENCE TO RELATED APPLICATION

This application claims priority to and the benefit of European Patent Application No. 22169616.4, filed in the European Patent Office on Apr. 25, 2022, and Korean Patent Application No. 10-2023-0053552, filed in the Korean Intellectual Property Office on Apr. 24, 2023, the entire content of both of which are incorporated herein by reference.

### BACKGROUND

### 1. Field

Aspects of embodiments of the present disclosure relate to a battery pack and an electric vehicle.

### 2. Description of the Related Art

Recently, vehicles for transportation of goods and peoples have been developed that use electric power as a source for motion. Such an electric vehicle is an automobile that is propelled by an electric motor using energy stored in rechargeable batteries. An electric vehicle may be solely powered by batteries or may be a hybrid vehicle powered by, for example, a gasoline generator or a hydrogen fuel power cell. A hybrid vehicle may include a combination of electric motor and conventional combustion engine. Generally, an electric-vehicle battery (EVB or traction battery) is a battery used to power the propulsion of battery electric vehicles (BEVs). Electric-vehicle batteries differ from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers, and camcorders, while high-capacity rechargeable batteries are used as power supplies for electric and hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as cylindrical or rectangular, may be selected based on the battery's intended purpose. Lithium-ion (and similar lithium polymer) batteries, widely known via their use in laptops and consumer electronics, dominate the most recent electric vehicles in development.

Rechargeable batteries may be used as a battery module formed of a plurality of unit battery cells coupled together in series and/or in parallel to provide a high energy content, such as for motor driving of a hybrid vehicle. The battery module may be formed by interconnecting the electrode terminals of the plurality of unit battery cells in a manner depending on a desired amount of power and to realize a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in series, parallel, or a mixture of both to deliver the desired voltage, capacity, and/or power density. Components of a battery pack include the individual battery modules and the interconnects, which provide electrical conductivity between the battery modules.

Mechanical integration of such a battery pack incorporates suitable mechanical connections between the individual components of, for example, battery modules, and between them and a supporting structure of the vehicle. These connections are designed to remain functional and safe throughout the average service life of the battery system. Furthermore, installation space and interchangeability standards must be considered, especially in mobile applications.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. These exothermic reactions include combustion of flammable gas compositions within the battery housing. For example, when a cell is heated above a critical temperature (typically above about 150° C.), the cell can transition into a thermal runaway. The initial heating may be caused by a local failure, such as a cell internal short circuit, heating from a defective electrical contact, or short circuit to a neighboring cell. During the thermal runaway, a failed battery cell, such as a battery cell that has a local failure, may reach a temperature exceeding about 700° C. Further, large quantities of hot gas are ejected (or emitted) from inside of the failed battery cell through the venting opening in the battery housing into the battery pack. The main components of the vented gas are H₂, CO₂, CO, electrolyte vapor, and other hydrocarbons. The vented gas is therefore flammable and potentially toxic. The vented gas also causes a gas-pressure to increase inside the battery pack.

A battery pack in the related art may not provide a dedicated channel for venting (also referred to as a venting channel, an exhaust or exhausting channel, or a channel structure). Instead, a volume within the battery pack might provide a path for hot venting gas to reach a venting element and an exterior of the battery pack. During to a thermal runaway, thermal propagation and pollution (e.g., a contamination by deposits of components of the venting gas) within the battery pack may occur, which may lead to an atmosphere which promotes arcing and/or a short circuit within the battery pack.

Typically in the related art, a structural element, a gas exhaust duct, or a gas duct is made of metal. In the event of a thermal runaway, electrical properties (e.g., electrical conductivity) of metal may cause electrical currents to flow unintendedly and/or uncontrollably, leading to arcing and/or a short circuit.

### SUMMARY

According to embodiments of the present invention, a mechanically stable battery pack is provided that efficiently uses construction space within the battery pack and that may, in the event of a thermal runaway, reliably guide a venting gas while reducing or minimizing the risk of arcing and/or of a short circuit.

The present disclosure is defined by the appended claims and their equivalents. Any disclosure lying outside the scope of the claims and their equivalents is intended for illustrative as well as comparative purposes.

According to one embodiment of the present disclosure, a battery pack includes: a housing; a plurality of battery cells accommodated within the housing, each of the plurality of battery cells including a degassing valve; a gas channel mounted to the housing as a structural member of the housing; and a thermally and electrically isolating sheet arranged between the battery cells and the gas channel. The isolating sheet is configured to provide conditional fluid communication between the gas channel and each of the degassing valves of the plurality of battery cells, and the conditional fluid communication depends on whether or not one of the battery cells is ejecting and/or has ejected a venting gas through the degassing valve of the battery cell.

According to another embodiment of the present disclosure, an electric vehicle including the battery pack as described above is provided.

Further aspects, features, and embodiments of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic view of an electric vehicle according to an embodiment.

FIG. 2 is a perspective top view of a battery pack according to an embodiment.

FIG. 3 is a bottom perspective view of a battery pack according to an embodiment.

FIG. 4 is a sectional view of a battery pack according to an embodiment.

FIG. 5 is another sectional view of a battery pack according to an embodiment.

FIG. 6 is perspective view of a portion of a battery pack according to an embodiment.

### DETAILED DESCRIPTION

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

According to one embodiment of the present disclosure, a battery pack includes a housing and a plurality of battery cells accommodated within the housing. Therein, each of the plurality of battery cells includes a degassing valve. The degassing valve is configured to release excess pressure from within the battery cell by ejecting (e.g., discharging) a venting gas into an area surrounding the battery cell. The excess pressure may result from a chemical reaction and/or a temperature above a reference (or predetermined) temperature threshold, such as occurs during a thermal runaway.

The battery pack includes a gas channel. The gas channel forms part of a venting path to conduct the venting gas. The venting path leads from the degassing valve via the gas channel through the battery pack. The gas channel directs and distributes the hot venting gas. Hence, risk of overheating or melting of battery cells other than the battery cell in the thermal runaway or of wiring insulation due to heat from the venting gas can be reduced. Further, pollution can be distributed in an inner space of the battery pack and, consequently, can reduce building up of an atmosphere inside the battery pack that leads to arcing. For example, the gas channel provides separation of venting gasses from a remaining volume inside the housing other than the gas channel. This prevents local pollution of the remaining volume inside the battery pack and prevents building up an atmosphere that promotes arcing.

The gas channel is mounted to the housing as a structural member of the housing. Thus, the gas channel (e.g., the venting channel) further enhances mechanical properties of the battery pack and/or the housing. The gas channel improves the stiffness of the battery pack because, under normal operating conditions, the gas channel may support (or counter) swelling forces at a cover face of the battery cells.

The battery pack includes a thermally and electrically isolating sheet, and the isolating sheet is arranged between the battery cells and the gas channel. The thermally and electrically isolating sheet prevents leakage currents between each of the battery cells and the gas channel and/or the housing, such as in case of a thermal runaway and/or if electrically conducting particles deposit within the gas channel. Furthermore, the thermally and electrically isolating sheet reduces heat transfer between a venting gas and the gas channel because the gas channel is thermally isolated from the venting gas. The thermally and electrically isolating sheet reduces heat transfer between a venting gas of a battery cell in thermal runaway and remaining battery cells (e.g., remaining live battery cells), which are battery cells not experiencing thermal runaway. The isolating sheet is arranged and configured to separate battery cells (e.g., the cell stacks) from the gas channel and from the housing.

The isolating sheet is configured to provide conditional fluid communication between the gas channel and each of the degassing valves of the plurality of battery cells. The conditional fluid communication depends on whether or not one of the battery cells is ejecting and/or has ejected a venting gas through the degassing valve of the battery cell. For example, if no thermal runaway occurs and/or has occurred in a battery cell, no venting gas is ejected or has been ejected through the degassing valve of the battery cell, and, hence, the gas channel and the degassing valve of the battery cell are not in fluid communication with each other. If a thermal runaway occurs and/or has occurred, a venting gas is ejected and/or has been ejected through the degassing valve of the battery cell, and, hence, the gas channel and the degassing valve of the battery cell are in fluid communication with each other through the isolating sheet. Thus, conditional fluid communication means that in case a venting gas needs to be discharged into the gas channel, the degassing valve and the gas channel are in fluid communication with each other. For example, the isolating sheet is configured to provide fluid communication between the gas channel and a battery cell that is or was in a thermal runaway condition and to block fluid communication between the gas channel and a live battery cell. Thereby, the venting gas can be discharged from the battery cell in thermal runaway into the gas channel but the remaining battery cells remain protected (e.g., remain thermally and electrically isolated from the gas channel and the vent gas). This minimizes the risk of arcing and/or of a short circuit because the venting gas of only the battery cell undergoing the thermal runaway is discharged in the gas channel, and the gas channel and the remaining live battery cells are reliably protected from heat and/or deposits of the venting gas.

The gas channel provides a mechanical stable battery pack that efficiently uses construction space within the battery pack. The gas channel and the isolating sheet provide, in conjunction with each other, that a venting gas is reliably guided through the battery pack in the case of a thermal runaway while the risk of arcing and/or of a short circuit is reduced or minimized.

According to one embodiment, the isolating sheet has a plurality of breaking sections, and each of the breaking sections is arranged to overlap one of the degassing valves of the battery cells and/or an outlet port of one of the degassing valves of the battery cells. For example, the isolating sheet is configured to break (e.g., burst) at well-defined sections if the pressure difference between opposite faces of the isolating sheet exceeds a reference (or predetermined) threshold, which is adjustable by the breaking sections. The breaking sections are arranged to overlap the degassing valves and/or outlet ports so that the degassing valves and/or outlet ports are covered by the isolating sheet and by the breaking sections. If a venting gas is ejected through one of the degassing valves and/or outlet ports by one of the battery cells in a thermal runaway, the breaking section that overlaps the degassing valve and/or the outlet port bursts so that the venting gas of the battery cell in thermal runaway can be discharged from the battery cell. The remaining breaking sections over the remaining battery cells that are not ejecting venting gas remain unbroken, and the remaining battery cells remain protected from heat and electric currents by the isolating sheet. Thus, the remaining battery cells are not in fluid communication with the gas channel. For example, the breaking section implies a conditional fluid communication between the battery cell and the gas channel.

According to one embodiment, each of the breaking sections is formed by a plurality of perforations and/or by a depression in the isolating sheet. This is a cost-effective method of forming the breaking sections and allow for precise arrangement of the breaking sections and a well-defined pressure threshold at which the breaking section is configured to break.

According to one embodiment, each of the breaking sections is configured to break at a reference (or predetermined) pressure and/or according to whether one of the battery cells is ejecting and/or has ejected a venting gas through the degassing valve of the battery cell. Thus, the breaking sections in the isolating sheet are configured to break if a thermal runaway occurs. If the thermal runaway occurs in one of the battery cells and the breaking section that covers the battery cell breaks, a venting gas can be ejected and e released from the battery cell in thermal runaway to the gas channel.

According to one embodiment, the gas channel is arranged above a cover face of each of the battery cells, and the isolating sheet is arranged between the gas channel and the cover faces of the battery cells. For example, the gas channel is arranged so that each of the battery cells can, in case of a thermal runaway, eject venting gas into the gas channel. Because the isolating sheet is arranged between the gas channel and the cover faces, fluid communication between a battery cell in thermal runaway ejecting venting gas and the gas channel is provided while the remaining battery cells remain covered by the isolating sheet so that the remaining battery cells are protected from heat and/or chemicals of the venting gas. The gas channel being arranged above the cover face means that the gas channel is arranged between the cover faces of the battery cells and a top cover of the housing. In another embodiment, the isolating sheet can be arranged at other locations, such as in a bottom section of the housing when a degassing valve is arranged to discharge a venting gas towards a bottom cover of the housing.

According to one embodiment, the gas channel is made of metal and/or steel, which provides improved stiffness of the housing. The gas channel is, thus, made from a material that resists a high-speed jet of hot venting gas containing small hot particles and/or chips. As an example, the gas channel can be made of a fire-resistant steel or mild steel.

According to one embodiment, the isolating sheet is clamped between the battery cells and the gas channel. This arrangement enables efficient manufacturing of the battery pack and a reliable arrangement of the isolating sheet between the battery cells and the gas channel.

According to one embodiment, the battery pack includes a common venting channel branching off from the gas channel, and in such an embodiment, the isolating sheet is configured to provide conditional fluid communication between the gas channel and the common venting channel. The common venting channel and the gas channel form a venting path or at least a part thereof along which a venting gas is guided. The gas channel guides the gas from each of the battery cells, for example, via a plurality of elongated gas channel portions, to the common venting channel so that venting gasses of a plurality of battery cells in a thermal runaway are guided to the common venting channel. The common venting channel may be a frame member of the housing. In some embodiments, the common venting channel is in fluid communication with an exterior of the housing to discharge the vent gas out of the battery pack to an exterior of the battery pack, for example, via a central outlet opening. The isolating sheet prevents pre-heating and/or pollution by a battery cell in thermal runaway of a battery stack adjacent to a battery stack that includes the battery cell in thermal runaway, for example, to prevent the pollution or preheating of the venting channel volume above the other battery cells and/or cell stacks. The conditional fluid communication between the gas channel and the common venting channel depends on the same condition as the conditional fluid communication between the gas channel and each of the degassing valves of the plurality of battery cells. In some embodiments, however, conditional fluid communication between the gas channel and the common venting channel depends on another condition as the conditional fluid communication between the gas channel and each of the degassing valves of the plurality of battery cells, such as a pressure threshold at which the isolating sheet provides a fluid communication differs from the other breaking sections.

According to one embodiment, the battery pack includes a plurality of cell stacks, and the common venting channel is arranged between at least two of the cell stacks. This provides an efficient arrangement of the common venting channel because the venting gas from the at least two cell stacks can be collectively guided by the gas channel to the common venting channel.

According to one embodiment, the housing includes at least one hollow beam, and the battery pack includes a venting path leading from the degassing valves of the battery cells through the at least one gas channel and the at least one hollow beam to an exterior of the battery pack. The hollow beam forms a part of the venting path. The hollow beam improves the usage of construction space within the battery cell and may provide a mechanically stiff structural element that improves mechanical characteristics of the housing.

According to one embodiment, the hollow beam has an upper beam section, a lower beam section in fluid communication with the upper beam section, and a separation member. The upper beam section and the lower beam section are separated from each other by the separation member. Thus, the venting path leads a venting gas via the upper beam section and the lower beam section. Thus, the horizontally arranged separation member increases a length of the venting path to further cool the venting gas as the venting gas moves through the hollow beam before being discharged to an exterior of the battery pack.

According to one embodiment, the separation member includes at least one fluid passage providing the fluid communication between the upper beam section and the lower beam section. This enables a well-defined layout of the venting path within the hollow beam. In some embodiments, the separation member includes one fluid passage per pair of cell stacks.

According to one embodiment, the at least one gas channel is arranged and configured to mechanically fix the plurality of battery cells. For example, the gas channel is configured as a fixation member for the battery cells (e.g., as a cell holder and/or cell retainer). The number of cell fixation members and/or the number of the fixation sections at which one or more of the battery cells are fixated can be reduced.

According to one embodiment, the housing includes a top cover, and the top cover is mounted to the gas channel. Mounting the gas channel to the top cover allows for efficient manufacturing of the battery cell, a space-saving arrangement of the gas channel, and may improve mechanical characteristics of the housing because the gas channel is arranged to mechanically support the top cover.

According to another embodiment of the present disclosure, an electric vehicle includes a battery pack according to the present disclosure. In some embodiments, the battery pack may include any of the above-described optional features to achieve a technical effect associated therewith.

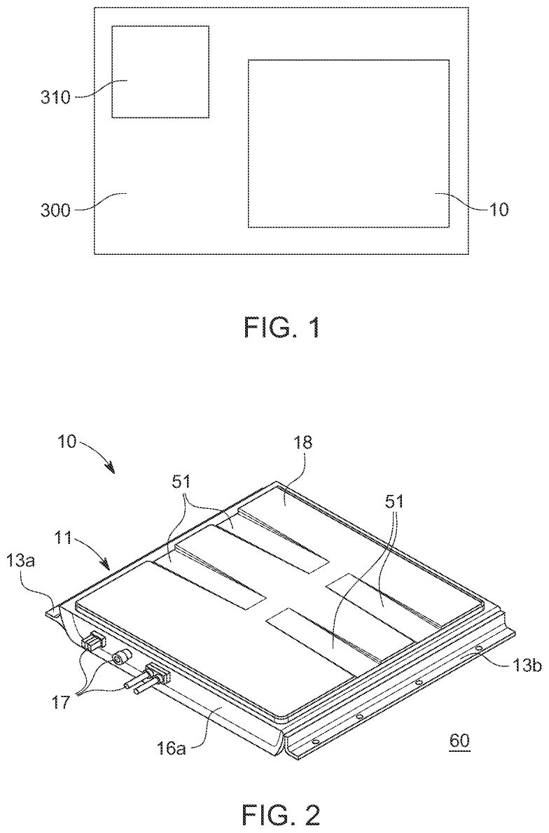

FIG. 1 is a schematic view of an electric vehicle 300 according to an embodiment.

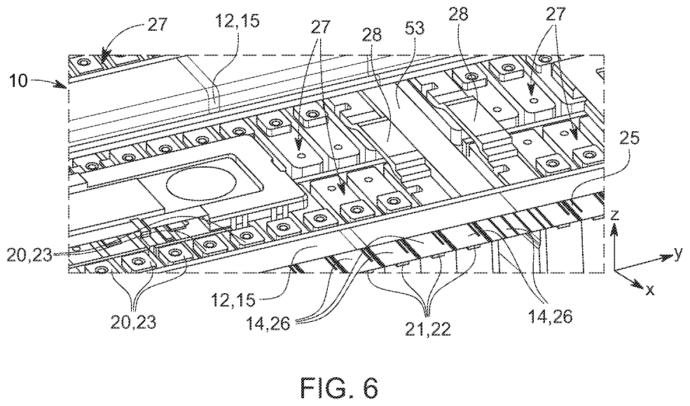

The electric vehicle 300 is propelled by an electric motor 310 using energy stored in rechargeable batteries cells 20 (see, e.g., FIGS. 4 and 6) arranged in a battery pack 10. The battery pack is described with reference to FIGS. 2 to 6.

FIG. 2 is a top perspective view of the battery pack 10 according to an embodiment.

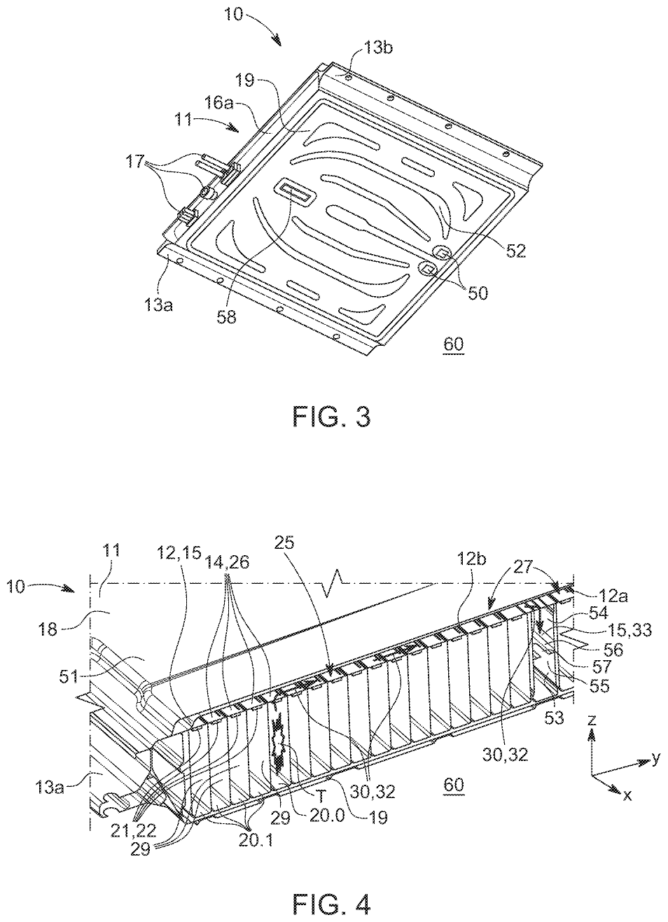

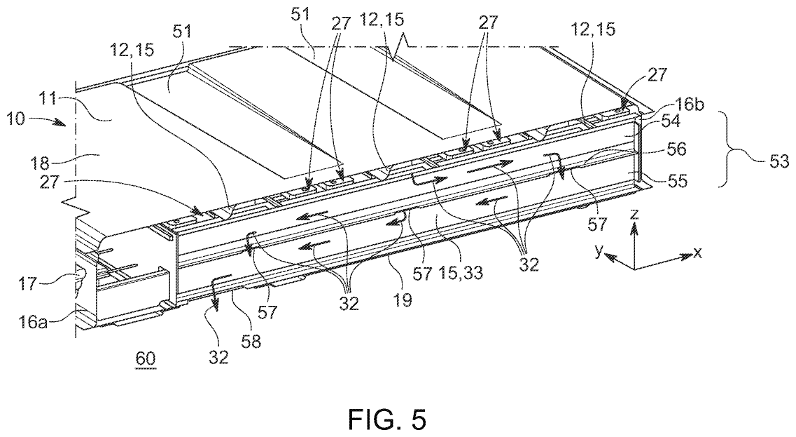

The battery pack 10 includes a housing (e.g., a battery housing) 11. The housing 11 includes two longitudinal beams 13a, 13b, two crossbeams 16a, 16b (see, e.g., FIG. 5), a top cover 18, and a bottom cover 19 (see, e.g., FIG. 3).

The longitudinal beams 13a, 13b are arranged parallel to each other, and the crossbeams 16a, 16b are arranged between the longitudinal beams 13a, 13b and perpendicular to the longitudinal beams 13a, 13b.

The housing 11 provides (or forms) an interior space between the two longitudinal beam 13a, 13b, the two crossbeams 16a, 16b, the top cover 18, and the bottom cover 19. A plurality of battery cells 20 is arranged as a plurality of cell stacks 27 in the interior space (see, e.g., FIGS. 4 to 6).

The top cover 18 is made of sheet metal and, as shown in FIG. 2, has a plurality of top cover depressions 51. The top cover depressions 51 are indentations and/or recesses in the top cover 18 and improve the stiffness of the top cover 18 and, thus, of the housing 11. A plurality of gas channels 12 is arranged below the top cover 18 and between and/or adjacent to the top cover depressions 51 (see, e.g., FIGS. 4 to 6).

A connector arrangement 17 is arranged at one of the crossbeams 16a for electrical interconnection between the battery pack 10 and an electric vehicle 300 and/or to provide temperature control.

FIG. 3 is a bottom perspective view of the battery pack 10 shown in FIG. 2.

The bottom cover 19 is made of sheet metal and, as shown in FIG. 3, has a plurality of bottom cover depressions 52 and a mounting arrangement 50. The bottom cover depressions 52 are indentations and/or recesses in the bottom cover 19. The bottom cover depressions 52 improve the stiffness of the bottom cover 19 and, thus, of the housing 11 and may allow or improve air circulation below the bottom cover 19 to provide venting. The mounting arrangement 50 is configured for mounting the battery pack 10 within and/or to the electric vehicle 300.

The bottom cover 19 has an outlet opening 58. The outlet opening 58 is a through-hole (e.g., an opening) in the bottom cover 19. The outlet opening 58 is configured to release a venting gas 30 (see, e.g., FIGS. 4 and 5) from within the battery pack 10 to an exterior 60 of (e.g., to the outside of) the battery pack 10.

FIG. 4 is a sectional view of the battery pack 10 shown in FIGS. 2 and 3. In FIGS. 4 to 6, cartesian coordinates x, y, and z are shown merely for ease of describing the arrangement of the battery pack 10 and its components.

As shown in FIG. 4, a plurality of battery cells 20.0, 20.1 (only a subset of battery cells 20.0, 20.1 is shown for ease of description) is arranged in the cell stacks 27. For example, the battery cells 20.0, 20.1 of one cell stack 27 are arranged in a stacked manner and parallel to each other. Therein, each of the battery cells 20.0, 20.1 has a longitudinal side surface 29 extending, in the drawings, in the x-z-plane. The longitudinal side surfaces 29 of the battery cells 20.0, 20.1 within the cell stack 27 contact an adjacent longitudinal side surface 29 of an adjacent battery cell 20.0, 20.1 within the cell stack 27. Each of the cell stacks 27 includes a plurality of battery cells 20.0, 20.1 stacked in the y-direction. Two cell stacks 27 are shown in FIG. 4.

One of the battery cells 20.0 is illustrated in a state of a thermal runaway T. The battery cell 20.0 in thermal runaway discharges a hot venting gas 30 as indicated by the arrows. The remaining battery cells 20.1 are battery cells 20.1 that may function regularly and may not be overheated. Thus, the plurality of battery cells 20.0, 20.1 as shown in FIG. 4 is divided in the battery cell 20.0 in thermal runaway T and the remaining battery cells 20.1.

The battery pack 10 has a gas channel 12. The gas channel 12 is arranged between the top cover 18 and each of the battery cells 20.0, 20.1. The gas channel 12 has a principal elongation in (e.g., primarily extends in) the y-direction. The gas channel 12 extends above the plurality of battery cells 20.0, 20.1.

The gas channel 12 is made of metal and/or steel. The gas channel 12 has a cross section to allow a high-pressure venting gas 30 to pass through the gas channel 12 and is not a barrier for hot venting gas 30 under high pressure.

The gas channel 12 is mounted to the housing 11 as a structural member 15 of the housing 11. For example, the top cover 18 and the gas channel 12 are mounted together. The top cover 18 is mechanically supported by the gas channel 12.

Each of the battery cells 20.0, 20.1 has a cover face (e.g., a top surface) 23 (see, e.g., FIG. 6). The cover face 23 is perpendicular to the longitudinal side surface 29 and, in the drawings, is arranged in the x-y-plane. The gas channel 12 is arranged above the cover face 23 of each of the battery cells 20.0, 20.1. Each of the battery cells 20.0, 20.1 has an outlet port 22 and a degassing valve 21 arranged at the cover face 23. The outlet port 22 is configured to enable fluid communication between an interior of the battery cell 20.0, 20.1 via the degassing valve 21 and an exterior of battery cells 20.0, 20.1. The degassing valve 21 is configured to discharge a venting gas 30 from the battery cell 20.0, 20.1 in the event of a thermal runaway T (e.g., when a reference pressure or greater is reached inside the battery cell 20.0, 20.1). The battery cell 20.0 in thermal runaway T discharges the venting gas 30 via the outlet port 22 and the degassing valve 21 into the gas channel 12.

The gas channel 12 is arranged and configured to mechanically fixate the plurality of battery cells 20.0, 20.1 (see, e.g., FIG. 6). The gas channel 12, that is, the venting channel, stiffens the structure of the battery pack 10 and/or the housing 11 in the x-y-plane, fixes the battery cells 20.0, 20.1 in the z-direction, and supports the top cover 18.

The battery pack 10 includes a thermally and electrically isolating sheet 25. The isolating sheet 25 is arranged between the battery cells 20.0, 20.1 and the gas channel 12. The isolating sheet 25 is configured to provide conditional fluid communication between the gas channel 12 and each of the degassing valves 21 of the plurality of battery cells 20.0, 20.1. The conditional fluid communication depends on whether or not one of the battery cells 20.0, 20.1 is ejecting and/or has ejected a venting gas 30 through the degassing valve 21 of the battery cell 20.0, 20.1. For example, the battery cell 20.0 in thermal runaway T is in fluid communication with the gas channel 12 so that the battery cell 20.0 can discharge the venting gas 30 into the gas channel 12 while the remaining battery cells 20.1 are not in fluid communication with the gas channel 12 because the isolating sheet 25 blocks and/or prevents fluid communication between the gas channel 12 and any of the battery cells 20.1. Thus, the battery cells 20.1 are separated from the venting gas 30 in the gas channel 12 by the isolating sheet 25.

The isolating sheet 25 has a plurality of breaking sections (e.g., predetermined breaking sections) 14. Each of the breaking sections 14 overlaps one of the degassing valves 21 and outlet ports 22 of the battery cells 20.0, 20.1. The breaking section 14 of the isolating sheet 25 has a venting geometry (e.g., a burst geometry) located above the degassing valves 21, which is the venting element of the battery cells 20.0, 20.1. Each of the breaking sections 14 (e.g., the venting openings) is configured to open (or burst) through in response to a jet of hot venting gas 30 being ejected from the battery cell 20.0 in thermal runaway T while preventing the remaining battery cells 20.1 from overheating by the still unbroken breaking sections 14 covering the battery cells 20.1. Thus, the battery cells 20.1 are shielded by the isolating sheet 25 from the venting gas 30 and are protected from heat and deposits of components of the venting gas 30.

Each of the breaking sections 14 is formed by a depression (or groove) 26 in the isolating sheet 25. For example, the isolating sheet 25 has a varying thickness, and the thickness is minimal (or smallest) at a breaking section 14 or at an edge thereof. Each of the breaking sections 14 is configured to break (or burst) at a reference (or predetermined) pressure and/or in response to one of the battery cells 20.0, 20.1 ejecting and/or having ejected a venting gas 30 through the degassing valve 21 of the battery cell 20.0, 20.1.

The isolating sheet 25 is arranged between the gas channel 12 and the cover faces 23 of the battery cells 20.0, 20.1 to separate the battery cells 20.0, 20.1 and the gas channel 12 from each other. The isolating sheet 25 is clamped between the battery cells 20.0, 20.1 and the gas channel 12.

The battery pack 10 has a common venting channel 33 arranged between a pair of the plurality of battery cells 20.0, 20.1. The common venting channel 33 branches off from the gas channel 12. The common venting channel 33 is arranged between adjacent cell stacks 27 and separates the adjacent cell stacks 27 from each other. The gas channel 12 includes two elongated gas channel portions 12a, 12b. The common venting channel 33 is perpendicular to the two elongated gas channel portions 12a, 12b. Each of the gas channel portions 12a, 12b is arranged above the battery cells 20.0, 20.1 of one of the battery cells stacks 27. The two elongated gas channel portions 12a, 12b merge into the common venting channel 33. The common venting channel 33 is formed by a hollow beam 53, which is further described below with reference to FIG. 5.

The isolating sheet 25 provides conditional fluid communication between the gas channel 12 and the common venting channel 33. Thus, the isolating sheet 25 conditionally prevents the venting gas 30 from passing through the common venting channel 33 but provides fluid communication between the gas channel 12 and the common venting channel 33 when, for example, a pressure difference between opposite faces of the isolating sheet 25 reaches a reference (or predetermined) pressure threshold.

FIG. 5 is another sectional view of the battery pack 10 shown in FIGS. 2 to 4.

The housing 11 includes the hollow beam 53 as described above with reference to FIG. 4. As shown in FIG. 5, the hollow beam 53 has an upper beam section 54, a lower beam section 55 in fluid communication with the upper beam section 54, and a separation member 56. The upper beam section 54 and the lower beam section 55 are separated from each other by the separation member 56. The separation member 56 has one fluid passage 57 per gas channel 12, that is, per pair of battery cell stacks 27, providing the fluid communication between the upper beam section 54 and the lower beam section 55.

The hollow beam 53 is arranged parallel to the longitudinal beams 13a, 13b and between the longitudinal beams 13a, 13b. The hollow beam 53 is arranged perpendicular to the crossbeams 16a, 16b. The common venting channel 33 is formed by (or within) the hollow beam 53 and provides a structural member 15 of the housing 11.

As illustrated in FIGS. 4 and 5, the battery pack 10 includes a venting path 32. The venting path 32 is a path through the battery pack 10 along which a venting gas 30 is guided as indicated by the arrows. The venting path 32 leads from the degassing valves 21 of the battery cells 20.0, 20.1 through the at least one gas channel 12 (e.g., through its elongated gas channel portions 12a, 12b), the hollow beam 53 (e.g., through the common venting channel 33), and outside the battery pack via the outlet opening 58 in the exterior 60 of the battery pack 10.

The gas channels 12 and the top cover depressions 51 are arranged alternatingly in the x-direction. For example, one of the top cover depressions 51 is arranged between an adjacent pair of gas channels 12.

In another embodiment, the common venting channel 33 is arranged on a lateral side of housing 11, for example, in one of the longitudinal beams 13a, 13b, and/or at a front or rear side, for example, in one of the crossbeams 16a, 16b.

FIG. 6 is a perspective view of a portion of the battery pack 10 shown in FIGS. 2 to 5.

The gas channel 12 is arranged above the plurality of battery cells 20. Thus, the gas channel 12 is arranged to mechanically fix the plurality of battery cells 20 and the isolating sheet 25, which is arranged between the gas channel 12 and the plurality of battery cells 20. The cell stacks 27, the isolating sheet 25, the gas channel 12, and the top cover 18 are pressed and/or mounted together to fix the arrangement of these components and to clamp the isolating sheet 25 between the gas channel 12 and the plurality of battery cells 20.

FIG. 6 shows the plurality of cell stacks 27. The battery pack 10 includes cell stack connectors 28. Each of the cell stack connectors 28 is configured to electrically interconnect a pair of cell stacks 27 with each other. As shown in FIG. 6, the cell stack connectors 28 are essentially flat and interconnect the pair of cell stacks 27 at the cover faces 23 of one of the battery cells 20 of each of the pair of cell stacks 27 with each other. This allows for efficient manufacturing of the cell stack connectors 28 and saves construction space within the battery pack 10 perpendicular to the cover faces 23 of the battery cells 20.

### SOME REFERENCE NUMERALS

10 battery pack
11 housing
12 gas channel
12a, 12b gas channel portion
13a, 13b longitudinal beam
14 breaking section
15 structural member
16a, 16b crossbeam
17 connector arrangement
18 top cover
19 bottom cover
20, 20.0, 20.1 battery cell
21 degassing valve
22 outlet port
23 cover face
25 isolating sheet
26 depression
27 cell stack
28 cell stack connector
29 longitudinal side surface
30 venting gas
32 venting path
33 common venting channel
50 mounting arrangement
51 top cover depression
52 bottom cover depression
53 hollow beam
54 upper beam section
55 lower beam section
56 separation member
57 fluid passage
58 outlet opening
60 exterior
300 electric vehicle
310 electric motor
x
y
z
cartesian coordinate, x-coordinate
cartesian coordinate, y-coordinate
cartesian coordinate, z-coordinate
T thermal runaway

What is claimed is:

1. A battery pack comprising:
a housing;
a plurality of battery cells accommodated within the housing, each of the plurality of battery cells comprising a degassing valve;
gas channel mounted to the housing as a structural member of the housing; and
a thermally and electrically isolating sheet, the isolating sheet being arranged between the battery cells and the gas channel,
wherein the isolating sheet is configured to provide conditional fluid communication between the gas channel and each of the degassing valves of the plurality of battery cells, the conditional fluid communication depending on whether or not one of the battery cells is ejecting and/or has ejected a venting gas through the degassing valve of the battery cell.

2. The battery pack according to claim 1, wherein the isolating sheet comprises a plurality of breaking sections, and
wherein each of the breaking sections respectively overlaps one of the degassing valves of the battery cells and/or an outlet port of one of the degassing valves of the battery cells.

3. The battery pack according to claim 2, wherein each of the breaking sections is formed by a plurality of perforations and/or by a depression in the isolating sheet.

4. The battery pack according to claim 2, wherein each of the breaking sections is configured to break at a reference pressure and/or in response to one of the battery cells ejecting and/or have ejected a venting gas through the degassing valve of the battery cell.

5. The battery pack according to claim 1, wherein the gas channel is arranged above a cover face of each of the battery cells, and
wherein the isolating sheet is arranged between the gas channel and the cover faces of the battery cells.

6. The battery pack according to claim 1, wherein the gas channel is made of metal.

7. The battery pack according to claim 1, wherein the isolating sheet is clamped between the battery cells and the gas channel.

8. The battery pack according to claim 1, wherein a common venting channel branches off from the gas channel, and
wherein the isolating sheet is configured to provide conditional fluid communication between the gas channel and the common venting channel.

9. The battery pack according to claim 8, wherein the battery pack comprises a plurality of cell stacks, and
wherein the common venting channel is arranged between at least two of the plurality of cell stacks.

10. The battery pack according to claim 1, wherein the housing comprises a hollow beam, and
wherein a venting path is formed leading from the degassing valves of the battery cells through the gas channel, and the hollow beam to an exterior of the battery pack.

11. The battery pack according to claim 10, wherein the hollow beam has an upper beam section, a lower beam section in fluid communication with the upper beam section, and a separation member, and
wherein the upper beam section and the lower beam section are separated from each other by the separation member.

12. The battery pack according to claim 11, wherein the separation member comprises a fluid passage providing conditional fluid communication between the upper beam section and the lower beam section.

13. The battery pack according to claim 1, wherein the gas channel is arranged and configured to mechanically fix the plurality of battery cells.

14. The battery pack according to claim 1, wherein the housing comprises a top cover mounted to the gas channel.

15. An electric vehicle comprising the battery pack according to claim 1.
